(19) United States
(12) Patent Application Publication
(10) Pub. No.: US 2004/0075750 A1
(43) Pub. Date: Apr. 22, 2004

(54) Flexible memory management for video and still image data in a digital camera

(75) Inventor: John Bateman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/272,737

(22) Filed: Oct. 16, 2002

(51) Int. Cl. H04N 5/76

(52) U.S. Cl. 348/231.1

(57) ABSTRACT

The memory of a digital camera is flexibly managed. When memory is available the camera will use it to capture the highest possible quality and highest possible resolution images. The user is allowed to specify a decrease and increase to the quality and compression settings of the image through the camera's user interface, effecting the size of the image file in memory. (always within the bounds of what can be supported by the amount of image data actually captured by the camera). The user specified settings are applied by the camera to the image data at a later time (e.g. only when the image data is finally downloaded to the host pc). In addition, the camera can store more data even after the memory is full.

In one embodiment, the user can input through the camera's user interface an increase in the quality (e.g., resolution/compression level or other such parameters) of an image or video file, after capturing and reviewing it, even after other data are subsequently captured on the camera. This can be done by storing data at a high quality setting when memory is available, and re-storing the data at a lesser quality if additional memory is not available. If memory is not available to store any additional data, and the user still attempts to capture additional data, data already stored on the device (and/or the attributes of the additional data) can be adjusted in order to make room for permanent storage of additional data on the camera.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

This invention relates generally to digital cameras for capturing still images and video, and more particularly, to the management of data stored in the memory of such devices.

2. Description of the Related Art

Digital cameras are increasingly being used by consumers to capture both still image and video data. One of the significant advantages of digital cameras over conventional cameras is that digital cameras store data electronically in the camera memory. The camera memory may be internal memory such as NAND Flash, etc., or external memory such as Compact Flash, Smart Media Card, SD, memory sticks, etc. These electronic data are then traditionally downloaded onto a host (e.g., a personal computer), and the camera memory can then be erased and re-used to capture additional data.

Memory management is thus a significant issue for digital cameras. One memory-related problem with digital cameras occurs when the user is, for some reason, unable to download data from the digital camera to the host. This could happen, for instance, when the user is away on a vacation and thus does not have access to her personal computer. After taking several pictures/video clips, the user may run out of memory on the camera. In conventional systems, if the user still wishes to capture more data at this point, he is informed that the camera's memory is full. Once this point is reached, in conventional systems, the user can take more pictures/video clips by either replacing the external memory (if an external memory slot, and a spare external memory device are both available), or by deleting some data that he has already captured and stored. Several cameras do not include external memory slots at all. Even when an external memory slot is available, once all available external memory devices are filled, the user is again left with the option of deleting some previously stored data in order to capture some more data. However, the user may not wish to delete any previously captured data to make additional space, and thus he may be unable to capture any more data in such a situation. Conventional digital cameras do not offer the user any alternative manners in which he can capture additional data in such a situation.

Another memory-related problem with digital cameras occurs when memory is available, but is not fully utilized. Several conventional systems permit a user to trade-off the resolution/size of the captured data against the amount of data that can be captured (E.g., the user is given control over the size of captured image files in at least two ways: (a) the camera allows the user to select the desired resolution at which successive images are captured, or (b) the camera allows the user to select the amount or type of compression that is applied to an image that is captured by the camera when it is compressed and saved to a file in memory). As technology advances make ever-higher resolution images possible, this situation becomes increasingly likely. The higher the resolution/size at which pictures are taken, the fewer the number of pictures that can be stored on the camera's memory. Thus a user may choose to capture data at a lower resolution/size in order to conserve memory, if the user estimates that he may capture a large amount of data before he downloads the data to the host and frees up the camera's memory. However, the user may make an error in this estimate. For example, the user may overestimate the number of pictures that he is likely to take before downloading them from memory, and thus he may choose a lower resolution/size level than necessary for storing these pictures. At a later time, after downloading the pictures to a host for instance, the user sometimes decides that he would have really liked to have captured a higher quality version of the image. The user may be interested in printing one or more of the pictures. The amount of information in the file directly affects print quality and the size of an image that can be printed at a given image quality level. In this way the user's earlier resolution and/or compression level selections directly affect the print quality. Further, this situation may be entirely unforeseen by less experienced users. Unfortunately the camera has thrown away the data that would make this possible in order to conserve space in memory, even though there may have been several excess megabytes of storage available in the memory since the time the image was captured. However, conventional digital cameras do not provide the user with a way of “going back in time” and obtaining the image at a higher resolution.

There is thus a need for a digital camera which can capture and store data at the highest possible resolution when memory is available, and then rescale data if necessary as the memory gets filled up. In addition, there is a need for a digital camera which will allow a user to capture additional data after the memory is full, without having to delete previously captured pictures in their entirety.

### BRIEF SUMMARY OF THE INVENTION

The present invention is a system and method for managing the memory of a digital camera in a flexible manner, so as to provide the user with high quality data when memory is available, and to allow the user to continue to capture more image data even when the memory is fully utilized. It is to be noted that the present invention relates to any type of data that can be captured by a digital camera, such as, but not limited to, still image, video, or audio data. For convenience, in some places “image” or other similar terms may be used in this application. Where applicable, these are to be construed as including any such data capturable by a digital camera.

According to one aspect of the present invention, if memory is available, the digital camera stores the data at the highest possible resolution, regardless of the user's previously indicated preferences. A digital camera in accordance with one embodiment of the present invention allows the user to specify through a user input element of the camera that the camera either increase or decrease the stored quality (e.g., resolution/compression level or other such parameters) of a particular image or video file, after capturing and reviewing it, even after other data are subsequently captured on the camera.

In one embodiment the change to the resolution/compression level input by the user is not necessarily acted upon immediately by the camera. E.g., the setting specified by the user may not be applied to the file until it is downloaded from the camera to a host such as the PC or a server. In this way it is possible for the user to specify a decreased resolution of a particular image file through the camera's user interface, and to then specify at a later time an increase back to the original resolution of the file through the camera's user interface without any perceivable loss of quality to the end user when the image file is download to the host.

In one embodiment of the present invention, memory is utilized when it is available by actually capturing data at the higher/highest quality setting possible. This higher quality data is then secretly kept in non-volatile memory until that memory is required by additional data captured by the user. This memory is not necessarily a separate contiguous block of memory. It may be composed of multiple memory segments. These memory segments may be part of the same file that includes the lower resolution memory data for the same image. Until that time the user is able to tell the camera to increase or decrease the quality of the image or video file that is eventually to be irrevocably committed to non-volatile memory. In one embodiment, the user is never aware of this extra data. If the user selects an image to be stored at a lower resolution, even though the data has been captured at the highest image resolution and quality, it is always displayed on the LCD and downloaded to the host, etc., at the (lower) image and quality settings selected by the user. The user might surmise the existence of the higher quality image data stored by the camera only if he requests a change in the image quality that requires the higher quality image data. In another embodiment, the user is initially provided with the high quality data that is stored in the memory of the camera, regardless of any lower quality settings which may be specified by the user. The data are restored at the lesser quality settings only if there is no additional memory available. In one embodiment, this lesser quality setting is previously specified by the user. In another embodiment, the lesser quality setting may be a default value, or determined by the camera based on an algorithm. The algorithm allows the user to increase resultant image quality up to the level supported by the actual captured image data, but no higher.

According to one aspect of the present invention, once no more memory is available to store any additional data, and the user still attempts to capture additional data, various alternatives are available. The data already stored on the device (and/or the attributes of the newly captured data) can be adjusted in order to make room for permanent storage of additional data on the camera. Examples of attributes are compression level, a.k.a. quality level, or resolution of the image.

In one embodiment, the user is presented with an alternative to deleting previously captured data. Such options may include allowing the user to select specific data from the data captured previously to determine which data to compress further, or which data to store at a lower resolution. In another embodiment, such reprocessing of previously stored data may be done automatically, based on a pre-determined algorithm. In one embodiment, the oldest data captured is automatically compressed further. In another embodiment, the data that is reviewed least by the user on the camera is automatically resized. In another embodiment all previously captured data is downscaled or compressed slightly, rather than downscaling or compressing a single picture by a more significant amount, to free up an equivalent amount of memory.

In some instances, capture of a single video file may consume all available memory before the user completes shooting the video. In such a situation, in one embodiment the camera automatically modifies (e.g., recompresses) the beginning portion of the video to free space to allow the user to continue to capture to the same video file.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of a system in accordance with an embodiment of the present invention.

FIG. 2 is a flowchart illustrating how a digital camera in accordance with an embodiment of the present invention maximizes memory utilization.

FIG. 3 is a flowchart illustrating an algorithm for a digital camera to store additional data in the memory after the memory is full, and without deleting previously captured data.

FIG. 4 is a flowchart which illustrates how additional data can be captured in accordance with one embodiment of the present invention.

FIG. 5 is a flowchart which illustrates how the beginning of a video file can be reprocessed when recording to the video file is continuing.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the present invention relates to any type of data that can be captured by a digital camera, such as, but not limited to, still image, video, or audio data. For convenience, in some places “image” or other similar terms may be used in this application. Where applicable, these are to be construed as including any such data capturable by a digital camera.

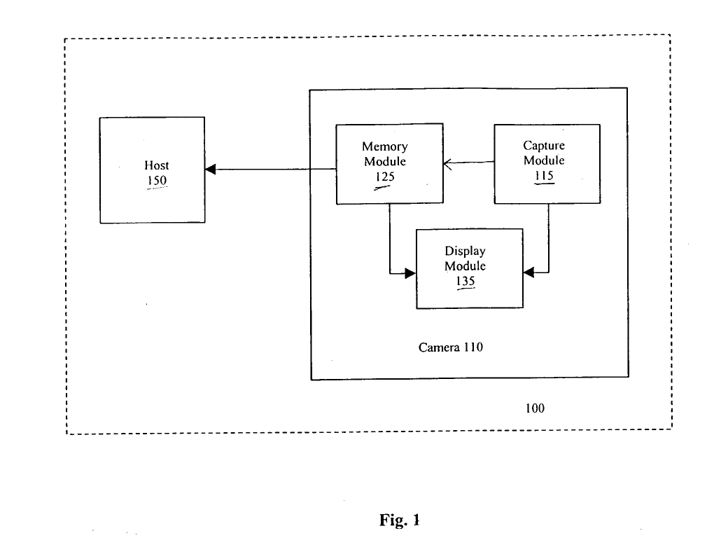

FIG. 1 is a block diagram of a system 100 in accordance with an embodiment of the present invention. The system 100 comprises a digital camera 110 and a host 150. The digital camera 110 further comprises a data capture module 115, a memory module 125, and a display module 135.

The capture module 115 captures data selected by the user. It will be evident to one of ordinary skill in the art that the data can be of any type that can be captured by a digital camera, such as, but not limited to, still image, video, or audio data.

The memory module 125 stores the data captured by the capture module 115. In one embodiment, the memory module 125 comprises only internal memory, such as NAND Flash, etc. In another embodiment, the memory module 125 comprises only external (or removable) memory, such as Compact Flash, Smart Media Card, SD, memory sticks, etc. In yet another embodiment, the memory module comprises both internal and external memory.

The display module 135 can display data stored in the memory module 125. In some embodiment, in addition, the display module 135 can display data captured by the capture module 115 (before it is stored) for preview purposes. In addition, in some embodiments, the display module 135 can also be used to receive instructions from the user. This can be done by allowing the user to select one of several options presented on the display module 135. The user can also select specific items of data (e.g., particular pictures) via the display module 135. In one embodiment, the display module 135 is comprised of a Liquid Crystal Display (LCD).

In one embodiment, the digital camera 110 can be connected to a host 150. In one embodiment, the host 150 can be a computer. In another embodiment, the host 150 can be a server, to which the digital camera 110 can send data (either directly, or through a cell-phone, etc.). Data stored in the memory module 125 can be downloaded to the host 150 and stored there. Once this is done, the data stored in the memory module 125 can then be deleted, so that new data can be captured by the capture module 115 and stored in the memory module 125.

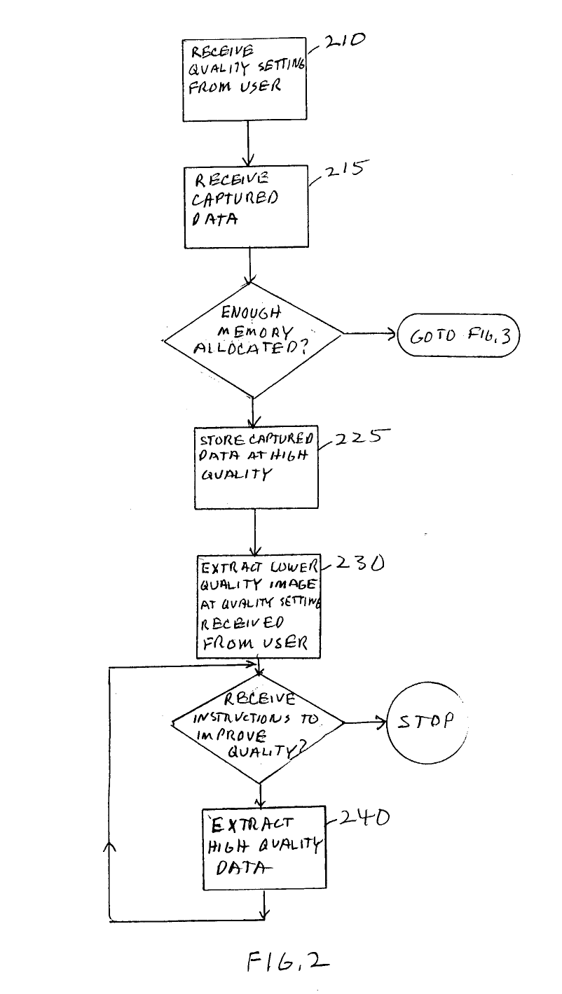

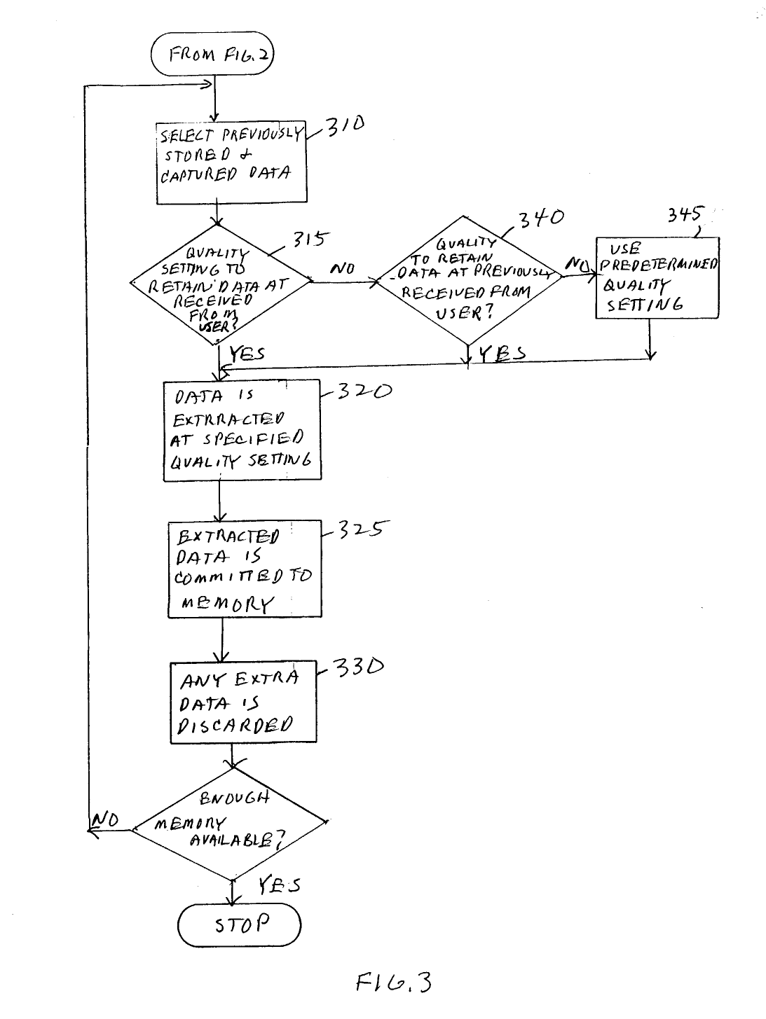

A digital camera 110 in accordance with an embodiment of the present invention can be used to maximize the utilization of the memory module 125 by storing data at the highest possible quality when memory is available. Further, a digital camera 110 in accordance with an embodiment of the present invention can be used to allow a user to capture additional data even when the memory module is completely filled, without deleting previously captured data. FIGS. 2 and 3 are flowcharts which illustrate how a digital camera 110 in accordance with embodiments of the present invention will operate.

FIG. 2 is a flowchart illustrating how a digital camera 110 in accordance with an embodiment of the present invention maximizes memory utilization.

It is to be noted that a trade-off exists between the amount of data stored in the memory module 125, and the quality of the stored data. That is, the higher the quality (e.g., resolution, size, etc.) of the data stored in the memory module 125, the smaller the amount of data (e.g., number of pictures) stored in the memory module 125. Therefore, in some embodiments of the present invention, digital camera 110 permits the user to select an image quality (e.g., resolution, compression level, size, etc.) at which the user desires to obtain the data. The digital camera 110 receives 210 the selected quality setting from the user. In one embodiment, a default quality setting is predetermined, and the digital camera 110 receives this default quality setting if the user does not modify it.

When the user uses digital camera 110 to captures a picture, the capture module 115 receives (step 215) the data captured by the user. In on embodiment of the present invention, the memory available in the memory module 125 is checked to determine (step 220) whether sufficient memory to store the captured data at a high quality setting is available. If enough memory is available, the captured data is stored (step 225) at the highest quality possible in the memory module 125. In other embodiments, if memory is available, the captured data is stored at some predetermined high quality in the memory module. The captured data is stored at the high (or highest) quality in the memory module 125, regardless of the quality setting for data capture specified by the user, if any. The user can continue to capture several more images, and the digital camera continues to store the data at a high quality, as long as memory is available in the memory module 125.

In one embodiment, the user is not made aware of this higher quality storing of the image unless he retroactively wishes to obtain the image at a higher quality. That is, the higher quality of the data is transparent to the user, unless he wishes to increase the quality of the data at a later time. If the user has selected a lower image quality at which the data should be stored, the desired lower image quality is extracted (step 230) from the higher image quality stored. Thus, even though an image has been stored at the highest image resolution and quality, it is always displayed on the LCD, downloaded to the host, etc., using the (lower) quality settings selected by the user. Until the memory utilized for storing the data at the high (or highest) quality is required by other data captured by the user, the user is able to retroactively instruct the digital camera 110 to increase (or decrease) the quality of the image that is eventually to be irrevocably committed to the memory module 125.

In one embodiment, the lower quality data as actually being stored in the same file as the high quality data. E.g., some image file formats allow maintaining image size/quality data in a single file that can be resolved to multiple image quality levels by a given algorithm. Such a file could be used to maintain the low and high quality data in a single file. Additionally, only certain pixels in an image file need to be sampled to produce a lower resolution image (and/or at a potentially smaller image width and height). A proprietary format could be used, or a commonly used format could be adapted, potentially progressive JPEG.

Another way to describe this is that a single image file is stored in memory in a persistent fashion with all the data in it for that image. The user specified settings detailing level of compression and image resolution and image width and height are stored separate from this file in a persistent fashion by the camera. Only when the image data needs to be downloaded to the host (pc or server), are the settings read by the camera (or host) and applied to the file data by a compression algorithm implemented in firmware, hardware, or software to produce an output file based on the user's settings.

The image data can also be compressed on the fly by the camera when the user chooses to review the image. The image can be sampled, and/or resealed, and/or the aspect ratio adjusted to produce an image that can be displayed on the camera's LCD (if it has one). Or, to quicken the display process, this LCD display image can be generated by the camera when the image is originally captured, and this image is thereafter displayed on the LCD to represent the image.

The user may review the data at the lower quality (e.g., on the display module 135 or on the host 150 screen), and determine that he wants the data at a higher quality. This determination could be based on one or more of several factors, such as the importance of the data to the user, the graininess of the data at the selected resolution, etc. The user may then instruct the digital camera 110 that he would like to increase the quality of the data.

When the digital camera 110 receives (step 235) such an instruction, the camera extracts (step 240) the higher quality data stored in the memory module 125 and provides it to the user.

One of ordinary skill in the art will note that the user could communicate such an instruction to increase the quality of the data to the digital camera 110 in one of several ways. In one embodiment, the user communicates this instruction to the digital camera 110 by manipulating a physical switch or button. In one embodiment, the user communicates this instruction to the digital camera 110 by interacting with software on the display module 135. In one embodiment, it is possible for the user to specify which aspects of quality of the data should be increased (e.g., increase in resolution, increase in size, increase in frame rate, etc.). In one embodiment, the user can specify by how much the various aspects of quality of the data should be increased. In one embodiment of the present invention, the quality of the data is increased in pre-determined increments, and can be increased repeatedly (until the maximum data quality—that is, the quality at which the data has been stored in the memory module 125—is reached). For instance, the user can keep pressing a button, and continue to obtain data of increased quality (until an increase in quality is no longer possible). In one embodiment, once the user is provided acceptable quality data, he can choose to “retain” that setting. It is to be noted that at this point the original (higher quality) data for that image continues to be stored in memory. Thus the user can still, at a later point, obtain data that is further improved in quality.

In another embodiment, when the user communicates the instruction for quality increase to the digital camera 110, the maximum possible quality data is provided to the user in a single increment.

It is to be noted that in an alternate embodiment, the higher quality of the data stored is not transparent to the user. In this embodiment, as long as memory continues to be available, when the data is displayed on the LCD, downloaded to the host, etc., the user sees the data at the higher image quality at which the data has been stored.

The user may continue to capture data. At some point, the memory module 125 gets filled up, and not enough space is available for the data that the user is capturing. The digital camera 110 in accordance with an embodiment of the present invention can no longer continue to store data at the highest possible quality. At this point, one of several algorithms can be implemented by the digital camera 110 in order to make room for additional data in the memory module 125.

In one embodiment, all previously stored data is re-stored at the predetermined quality setting (which could either be a default or be provided by the user). The corresponding data at the higher quality setting is discarded. In another embodiment, the oldest previously stored data is re-stored at the predetermined quality setting, and the corresponding data at the higher quality setting is discarded. The availability of the memory is then checked. If sufficient memory is still not available, the next oldest previously stored data is processed in the same manner, and so on, until enough memory is available.

FIG. 3 illustrates yet another embodiment by which a digital camera 110 is able to store additional data in the memory module 125, after the memory is full, without completely deleting previously captured data. In this embodiment, specific data previously captured and stored by the user is selected (step 310). As described above, in an alternate embodiment, the user does not select this data, but rather the oldest data captured by the user is selected as a default.

If the user selects (step 315) a quality setting at which to retain the data, the image data is extracted (step 320) at this quality setting, and the image is irrevocably committed (step 325) to memory at that quality setting. Any extra data originally captured for that image is discarded (step 330). The memory availability is then checked (step 335). If enough memory is available to store the additional data captured by the user, nothing further is done. If not, more specific data previously captured and stored by the user is selected, and processed in a similar manner. This irrevocable committing of images to memory and purging of excess data progressively continues as more and more data are captured by the user.

If the user does not select (step 315) a quality setting at which to retain the data, a check is performed to determine (step 340) whether the user had earlier (e.g., at the initial setup of the camera) selected a quality setting at which to store data. If so, the image data is extracted (step 320) at this quality setting, and the image is irrevocably committed (step 325) to memory at that quality setting. Any extra data originally captured for that image is discarded (step 330).

If the user has not initially selected a quality setting at which to store data, a pre-determined default quality setting is used (step 345). The image data is extracted (step 320) at this quality setting, and the image is irrevocably committed (step 325) to memory at that quality setting. Any extra data originally captured for that image is discarded (step 330).

One of ordinary skill in the art will note that algorithms such as the one outlined in FIG. 3 can be used to make room for storage of additional data on a digital camera in accordance with an aspect of the present invention, even when the memory management described with respect to FIG. 2 above is not used. A camera in accordance with this aspect of the present invention will be useful in several scenarios. For instance, at the time that the memory on the camera gets full, a user may be away from the host 150, and thus be unable to download data from the memory module 125 to the host 150. The user may, however wish to capture additional data, and at the same time, not wish to delete any previously captured images to make additional space.

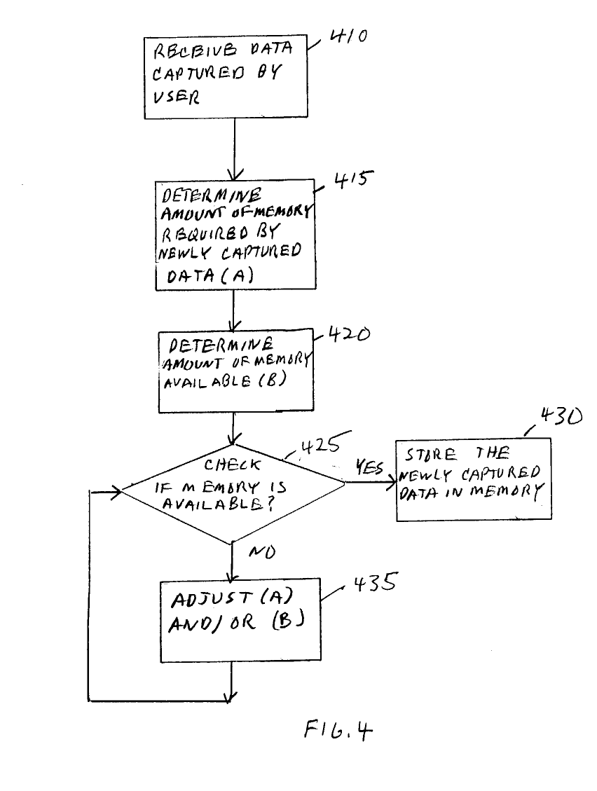

When the memory in the camera 110 gets filled up, and the user still wishes to capture additional data without deleting previously captured data, a camera in accordance with one aspect of the present invention will automatically create space in memory to accommodate the newly captured data. FIG. 4 is a flowchart which illustrates how such additional data can be captured in accordance with one embodiment of the present invention.

The camera 110 receives (step 410) data captured by the user. The camera determines (step 415) how much memory is required to store the newly captured data. This determination is based upon the current quality settings. The camera then determines 420 the memory available on the digital camera 110, which is affected by the total amount of memory available on the camera itself and on any removable storage media on the camera, minus the amount of memory already consumed by previously captured images and associated metadata. One of ordinary skill in the art will note that such determinations (steps 415 and 420) can be made in hardware, software, firmware, or any other way.

Based on the determinations (steps 415 and 420), the camera checks (step 425) if enough memory is available. If enough memory is available, the newly captured data is stored (step 430) in memory. If enough memory is not available, the camera then adjusts (step 435) the memory necessary to store the newly captured data, and/or the memory occupied by previously captured data, to make room for storage of the newly captured data.

In order to reduce the memory necessary to contain the newly captured image, in one embodiment, the camera firmware can reduce the image resolution and/or compression quality of the new image so that it just fits within the available storage space. In one embodiment, these settings can be changed by the camera firmware before the new image is captured, or after it is captured, but before the image is committed to memory.

In order to reduce the memory occupied by previously captured images, in one embodiment, the camera firmware recompresses them at a higher compression level. In another embodiment, the camera firmware resizes the previously captured images to a smaller size. In still another embodiment, the new or old images can be converted to a lower color resolution.

Modifying the compression quality of the data means different things depending on the compression scheme. If the video is made up of a succession of individually compressed frames, the modifying of the compression quality would modify the compression applied to each frame by the compression algorithm. If an interframe compression scheme is used, then modifying the compression level might also alter the frequency of key frames in the compressed data. In yet another implementation, the output video may be modified in width and height.)

One of ordinary skill in the art will note that the adjustments (step 435) can be made by any predetermined algorithm. For example, in one embodiment, metadata associated with image data (e.g., thumbnails etc.) that has been stored in memory is purged to free up memory. In another embodiment, some storage/memory can be held in reserve internal to the camera. This reserve memory is not taken into consideration when the camera determines (step 420) how much memory is available. This memory is invisible to the user. When it is determined (step 425) that enough memory is not available, and the user still captures new data, the newly captured data is stored on this reserve memory. This reserve memory allows the newly captured data to be stored without any time lag. In the meanwhile, when the reserve memory is accessed, the previously captured images can be re-processed to make room on the “main” memory.

In another embodiment, the user is given the option to insert another piece of removable media to hold the new image.

Such predetermined algorithms can be programmed into the camera 110, or can have parameters which are previously selected by the user. For instance, the user may be able to specify whether, when the memory is full, the camera should adjust the newly captured data, or the previously captured data, or both. The user may also be able to specify which adjustment to make first, how much specific parameters should be altered, etc. For instance, these adjustments/parameters can include adjusting the frame size (e.g., width, height), decreasing the color resolution, decreasing quality settings on the compression algorithm, switching for M/JPEG compression of video to an interframe compressed MPEG4, decreasing frame rate of the video, etc. In another embodiment, if the user does not desire to provide these inputs to the camera, a default algorithm can be used.

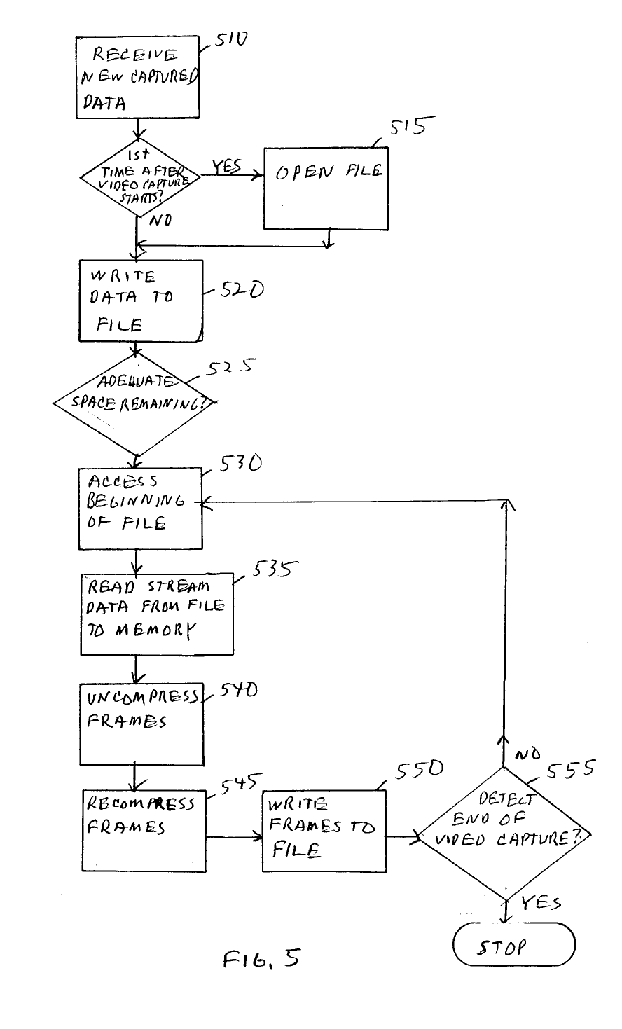

In some instances, capture of a single video file may consume all available memory before the user completes shooting the video. In such a situation, in one embodiment the camera automatically modifies (e.g., recompresses) the beginning portion of the video to free space to allow the user to continue to capture to the same video file. FIG. 5 is a block diagram of an embodiment of the present invention in which this is illustrated.

In one embodiment of the present invention, when newly captured video data is received (step 510), a new file is opened (step 515) to store (step 520) the newly captured video data. Captured video data is written 520 to the file. It is then determined (step 525) whether adequate space is remaining on the memory. The determination of how much space is considered “adequate” can be made in one of several ways. For instance, in one embodiment, “adequate” space on memory can be defined as space sufficient to hold 10 seconds of video, based on a predefined formula, and/or an estimate of the maximum data size per second of recording.

If adequate space is remaining on the memory, the software data is continued to be written (step 520) to the file. If adequate space is not remaining on the memory, the beginning of the file is accessed (step 530). The data from the file is then read (step 535) into memory. The frames from the beginning of the file are then uncompressed (step 540). These frames are then recompressed (step 545). The recompressed frames are then written back to a file (step 550). When the end of the video capture is detected (step 555), the recompression of the frames from the beginning is stopped (step 560).

In one embodiment, the file to which the recompressed frames are written back is the same file to which the newly captured video is being written. In such an embodiment, the file is simply closed after recompression is stopped (step 555). In another embodiment data is compressed to a file A with a moderate level of compression. When the camera firmware decides that memory is becoming scarce it begins to compress data to file A in a more highly compressed format. When video capture terminates File A is closed. File B is opened and frames from file A are read and recompressed to file B in the more highly compressed format if they are not already in this format. Once recompression completes, file A and B are closed. File A is deleted. Note that the camera might begin recompressing the data in file A to file B as soon as the camera switches capture to the more highly compressed format.

In another embodiment data is compressed to a file A with a moderate level of compression. When the camera firmware decides that memory is becoming scarce it closes file A and opens a file B. New data is captured to file B. When video capture terminates File B is closed. The Data in file A is recompressed and written to file C. File B is then appended to file C. File A is Deleted. Note that the camera might begin recompressing the data in file A to file C as soon as file A is closed.

The algorithms for capturing additional data without completely deleting previously captured data, can be initiated in one of several ways. In one embodiment, the user can initiate the algorithm by clicking a software button. The user clicks a software element (e.g., button, menu item, etc.) on the camera display module 135 to initiate the algorithm. In one embodiment, the software may automatically prompt the user to initiate this process when a low memory condition occurs.

The user navigates through a set of options available on the camera through the user interface displayed on the display module 135. In one embodiment, the user undertakes this task after being notified by the camera in some fashion (e.g., LCD displays “FULL”) that there is insufficient memory available to store one more picture. In another embodiment, the user clicks a designated hard button on the camera case to initiate the algorithm. In yet another embodiment, the algorithm is automatically initiated by the camera 110 when the memory is full and the user attempts to capture new data. In still another embodiment, when the memory is full and the user attempts to capture new data, the camera 110 prompts the user. The user is asked if he would like the camera to employ the algorithm to fit this new image into non-volatile memory.

It is to be noted that in one embodiment, the algorithm can be used only once between purgings of the non-volatile memory. In another embodiment, the algorithm is allowed to be repeatedly applied to the data stored on the camera for the same set of images. In yet another embodiment, a user may be able to select whether the algorithm can be used only once or used repeatedly.

While particular embodiments and applications of the present invention have been illustrated and described, it is to be understood that the invention is not limited to the precise construction and components disclosed herein. For example, the various embodiments of the present invention described above can be implemented in hardware, software, firmware, etc. Regardless of data type (video, audio, image) the output data file is ultimately desired to occupy a given size, and there are a number of ways to achieve this size: changing compression scheme, modifying compression parameters, modifying width and height of output frame(s), modifying color resolution, eliminating audio portion associated with a video (new), modifying the video frame rate, modifying resolution. Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A method for managing memory in a digital camera, wherein the camera has previously stored data, and a user captures new data using the digital camera, the method comprising:
assessing space required to store the newly captured data;
assessing space available in the memory;
in response to the space available in the memory being less than the space required to store the newly captured data, processing the previously stored data to increase the space available in the memory in order to store additional data.

2. The method of claim 1, wherein the previously stored data and the newly captured data are video data.

3. The method of claim 2, wherein processing the previously stored data comprises modifying one of the frame rate of the previously stored data and the compression quality of the data.

4. The method of claim 1, wherein the previously stored data and the newly captured data are still image data.

5. The method of claim 4, wherein processing the previously stored data comprises modifying the frame size of the previously stored data.

6. The method of claim 1, wherein processing the previously stored data comprises modifying the color resolution of the previously stored data.

7. The method of claim 1, wherein processing the previously stored data comprises modifying the compression of the previously stored data by modifying one of the compression algorithm used and the compression level setting used to compress the data.

8. The method of claim 1, wherein the memory being managed is non-volatile memory.

9. A method for managing memory in a digital camera, wherein a user uses the digital camera to capture and store data, the method comprising:
receiving a predetermined quality setting;
receiving captured data to store to memory;
in response to the space available in the memory being more than the space required by the captured data storing the captured data at a quality setting higher than the pre-determined quality setting; and
extracting the captured data at the predetermined quality setting for displaying to the user.

10. The method of claim 9, further comprising:
in response to receiving instructions to improve the quality of the image, extracting the stored high quality data for displaying to the user.

11. The method of claim 9, wherein the predetermined quality setting is received from the user.

12. A method for managing memory in a digital camera, wherein the camera has previously stored data, and a user captures new data using the digital camera, the method comprising:
receiving the newly captured data;
in response to space available in the memory being less than space required by the newly captured data selecting the previously stored data;
extracting from the previously stored data, modified data at a predetermined quality setting;
storing the extracted modified data in the memory; and
deleting the previously stored data.

13. The method of claim 12, wherein selecting the previously stored data is performed by the user.

14. The method of claim 12, wherein selecting the previously stored data is performed by the camera, based on a time at which the previously stored data was stored in the camera.

15. The method of claim 12, wherein the modified data comprises the previously stored data at a lower resolution.

16. The method of claim 12, wherein the modified data comprises the previously stored data re-compressed using a different compression algorithm.

17. The method of claim 12, wherein the modified data comprises the previously stored data further compressed.

18. A camera with flexible memory management, the camera comprising:
a capture module for capturing data;
a memory module communicatively coupled to the capture module, wherein the memory module can re-process previously stored data when the memory module is full, so as to accommodate additional data captured by the capture module; and
a display module communicatively coupled to the capture module and the display module, for displaying the captured data and the stored data.

19. A camera with flexible memory management, the camera comprising:
a capture module for capturing data;
a memory module communicatively coupled to the capture module, wherein in response to sufficient memory being available in the memory module
the data captured by the capture module is stored at a high quality setting;
in response to sufficient memory not being available in the memory module
data previously stored in the memory module is extracted;
the extracted data is modified to correspond to a pre-determined
quality setting lower than the high quality setting;
the modified data is stored in the memory module;
the previously stored data is deleted from the memory module; and
a display module communicatively coupled to the capture module and the display module, for displaying the captured data and the stored data.

20. A method for managing memory in a digital camera, wherein the camera has previously stored video data, and a user captures new video data using the digital camera, the method comprising:
opening a video file in the memory of the camera;
writing the captured video data to the video file;
in response to adequate space not remaining on the memory accessing the beginning of the video file;
uncompressing a frame at the beginning of the video file; and
recompressing the frame.

21. The method of claim 20, further comprising:
writing the recompressed frame to the video file.

22. The method of claim 20, further comprising:
writing the recompressed frame to a second video file.
